(19) United States
(12) Patent Application Publication
(10) Pub. No.: US 2013/0171304 A1
(43) Pub. Date: Jul. 4, 2013

(54) SYSTEM AND METHOD FOR CULINARY INTERACTION

(71) Applicant: ROBERT E. HUNTLEY, Houston, TX (US)

(72) Inventor: ROBERT E. HUNTLEY, Houston, TX (US)

(21) Appl. No.: 13/545,680

(22) Filed: Jul. 10, 2012

Related U.S. Application Data
(60) Provisional application No. 61/507,723, filed on Jul. 14, 2011.
(60) Provisional application No. 61/590,140, filed on Jan. 24, 2012.

(51) Int. Cl. G06F 3/0481

(52) U.S. Cl. CPC G06F 3/04817
USPC 426/231; 434/127

(57) ABSTRACT

A computerized system and method are disclosed, the method including but not limited to presenting an interactive cooking menu on a client processor display; receiving on the client device an input regarding the cooking menu and responding to the input. A system is disclosed for performing functions useful in presenting an interactive cooking menu on a client processor display; receiving on the client device an input regarding the cooking menu and responding to the input.

### CROSS REFERENCE TO RELATED PATENT APPLICATIONS

The patent application claims priority from U.S. Patent Application Ser. No. 61/507,723 filed on 14 Jul. 2011 entitled A System and Method for Culinary Interaction by Robert E. Huntley which is hereby incorporated by reference in its entirety and U.S. Patent Application Ser. No. 61/590,140 filed on 24 Jan. 2012 entitled A System and Method for Culinary Interaction by Robert E. Huntley which is hereby incorporated by reference in it entirety.

### BACKGROUND OF THE INVENTION

1. Field of the Invention

The present invention relates to the field of culinary preparation.

2. Background of Related Art

Conventional cooking methods are limited by the tools of the past and limited skill of the user. It is known for a food company to deliver food bought over the Internet. It is also known that cooking recipes may be found on the Internet. Cooking appliances include, without limitation, electric and gas cook tops, ovens, and ranges (i.e., an appliance containing both a cook top and an oven) and microwave ovens. An oven is on the market which uses an upper and a lower halogen lamp and/or microwaves for cooking and which includes a computer. This oven comes with over 100 preset recipe cooking programs which automatically set the cooking time, the power level of the upper halogen light, the power level of the lower halogen light, and the power level of the microwaves depending on computer-prompted user-inputs for the type of food (e.g., chicken), the specific kind of food (e.g., boneless), the total weight of food (e.g., one pound), the number of pieces of food (e.g., two), and the desired doneness (e.g., well done). The user can input up to thirty additional recipe cooking programs by program number (e.g., one), cooking time (e.g., ten minutes), the power level of the upper halogen light (e.g., six), the power level of the lower halogen light (e.g., seven), and the power level of the microwaves (e.g., four). The oven then will automatically cook the food and alert the user when the cooking is completed. What is needed is a cooking appliance which makes cooking more convenient.

### SUMMARY OF THE INVENTION

A computerized method is disclosed, the method including but not limited to presenting an interactive cooking menu on a client processor display; receiving on the client device an input regarding the cooking menu and responding to the input. A system is disclosed for performing functions useful in presenting an interactive cooking menu on a client processor display; receiving on the client device an input regarding the cooking menu and responding to the input.

### BRIEF DESCRIPTION OF THE DRAWINGS

FIG. 1 depicts a schematic representation of an interactive cooking menu in a particular illustrative embodiment;

FIG. 2 depicts a schematic representation of an interactive cooking sub menu in a particular illustrative embodiment;

FIG. 3 depicts a schematic representation of an interactive cooking sub menu in a particular illustrative embodiment;

FIG. 4 depicts a schematic representation of an interactive cooking sub menu in a particular illustrative embodiment;

FIG. 5 depicts a schematic representation of an interactive cooking menu in a particular illustrative embodiment;

FIG. 6 depicts a schematic representation of an interactive cooking sub menu in a particular illustrative embodiment;

FIG. 7 depicts a schematic representation of a food aging tracking system at a point of purchase location;

FIG. 8 depicts a schematic representation of a client device interacting with a smart hood in a particular illustrative embodiment;

FIG. 9 depicts a schematic representation of a client device interacting with a smart hood in a particular illustrative embodiment;

FIG. 10 depicts a schematic representation of an interactive cooking menu in a particular illustrative embodiment;

FIG. 11 depicts an apron mounted imaging device in a particular illustrative embodiment; and

FIG. 12 depicts a view from a user mounted imaging device during use of a particular illustrative embodiment.

### DETAILED DESCRIPTION OF THE INVENTION

In a particular illustrative embodiment, a computerized method is disclosed, the method including but not limited to presenting an interactive menu of cooking icons on a client device display; receiving on the client device an input regarding the interactive menu of cooking items; and responding to the input. In another particular embodiment, the interactive cooking menu is a plurality of interactive icons and the input indicates progress toward accomplishment of a task related to a first one of the interactive icons. In another particular illustrative embodiment, the method further includes but is not limited to changing a presentation of the interactive cooking menu of cooking icons display to move to a second presentation of an interactive icon operationally related to the first interactive icon; measuring a time to complete a first task related to the first interactive icon; and storing a time complete the first task related to the first icon for an identified user.

In another particular embodiment, the menu is a plurality of interactive cooking icons and the input is a data input from a client device user wherein the data input indicates a request for one of instructional and historical information about an interactive cooking icon, the method including but not limited to presenting instructional information on how to perform a task associated with the icon, and presenting historical information related to the icon, wherein the historical information relates to a recipe origin. In another particular embodiment, the input relates to the interactive cooking menu of icons, the responding to the input comprises posting the input to a social network. In another particular embodiment, the input is a request for a recipe suggestion based on identification of expected dinner guests and their associated culinary profiles, the method further including but not limited to gathering culinary preference information from social media indicating the expected dinner guests likes, dislikes, recent meals from a categorical selection of restaurants (Italian, French, Americana Diner Fare, Fine Dining, Vietnamese, Thai, etc.) based on FOURSQUARE™ application inputs from a user locator application such as FOURSQUARE™, food purchases from grocery stores or indicated as used on the computer cooking method is stored in data base, foods not purchased from store or used on a particular cooking method. In another particular embodiment, the input is a request for recipe suggestion based on food aging wherein the age of the food comes from a central data base updated when a use identified makes a food purchase from a grocery store purchase. The grocery store tracks the age of the food upon arrival at the grocery store and stores the age food as an inventory in data base. When the user purchases the food, a user profile is updated by a grocery store check out scanner processor. On the date of purchase of the food showing historical food purchases and the age of the food purchased along with the identity of the user.

In a particular embodiment, the user profile in the data base is accessible by a user through the client device so that a user can update an inventory of food items and aging data for food purchased from the grocery store and used during cooking or removed from inventory due to spoliation because of aging of the food. The client device also generates a grocery list of needed food items in the data base so that the grocery list is ready to print automatically when a user visits a grocery store. The grocery list can be automatically generated at the client device or at the grocery store via a grocery store processor in data communication with the data base. A client device may request a menu of recipe based on the age of the food, for example, a recipe for freshest food or a recipe for food that is oldest and needs to be used in a recipe to avoid spoliation. A client device can also access user profiles for other users to determine food likes and dislikes and recent recipes prepared by the other users. In another particular embodiment, the input is a request for recipe suggestion based on time to cook and the learned cooking time of a user for a recipe.

In another particular embodiment, the input is motion sensor input such as data from a Kinect infra red motion tracking system. Motion data is provided along with an image of a cooking utensil and actions associated with the cooking utensil, the method further including but not limited to determining a size and type of the cooking utensil from the image; determining a user action associated with the cooking utensil from the image; and controlling the oven temperature and interactive cooking menu based on the determining of the size and type of utensil and the action. The cooking utensils can include but are not limited to cookware (pots, pans, boilers, etc.), forks, knives, spoons and spatulas.

In another particular embodiment, the input is temperature data from an infra red thermometer having an infra red temperature beam probe of identified food being cooked according to the interactive cooking menu wherein a camera and processor are used to aim and identify food being cooked and the temperature probe to an identified food being cooked. The infra red thermometer is aimed by camera that identifies and locates food, cooking utensils, cookware and heating elements on a stove top occupied by the user of the client device. In another particular embodiment, the input is a color data input from a camera associated with the client device and indicating color as an indicia of progress of a food cooking, the method further includes but is not limited to controlling cooking temperature and presenting status of the food cooking based on the color of the food. In another particular embodiment, the input is a texture data input indicating a food cooking progress the method further including but not limited to controlling cooking temperature and presenting status of the food cooking based on the texture of the food. In another particular embodiment, the input is a gas chromatograph data input indicating a simulated sense of smell from a gas chromatograph for indicia of food cooking progress, the method further including but not limited to controlling cooking temperature and presenting status of the food cooking based on the gas chromatograph analysis of the food, an identified action and an identified utensil wherein the camera identifies the action and the utensil. In another particular embodiment, the camera, chromatograph and temperature are used to generate a status for a food being cooked. While a gas chromatograph is described herein to simulate a sense of smell to help to determine the progress of food being cooked, a mass spectrometer or infrared spectrometer can also be used to simulate the sense of smell to help to determine the progress of food being cooked.

In another particular embodiment, a system is disclosed including but not limited to a client device processor in data communication with a non-transitory computer readable medium; a computer program comprising instructions embedded in the non-transitory computer readable medium, that when executed by a computer perform function useful cooking, the computer program including but not limited to instructions to present from a client device processor, an interactive cooking menu on a client device display; instructions to receive on the client device an input regarding the cooking menu; and instructions to respond to the input. In another particular embodiment of the system the interactive cooking menu is a plurality of interactive icons and the input indicates progress toward accomplishment of a task related to a first one of the interactive icons. In another particular embodiment of the system the computer program further includes but is not limited to instructions to change the interactive cooking menu display to move to a second interactive icon related to the first interactive icon; instructions to measure a time to complete a first task related to the first interactive icon; and instructions to store a duration indicating a time to complete the first task for a particular identified user.

In another particular embodiment of the system, the menu is a plurality of interactive recipe icons and the input indicates a request for one of instructional and historical information about an icon, the method further including but not limited to a set of instructions to present instructional information on how to perform a task associated with a particular interactive icon, and presenting historical information related to the icon, wherein the historical information relates to a recipe origin. In another particular embodiment of the system the input is a request for a recipe suggestion based on expected dinner guests, the computer program further including but not limited to instructions to gather at the client device, culinary preference information from social media on the internet indicating the expected dinner guests likes, dislikes, recently visited restaurants, food purchases from store or indicated as used on the computer cooking method in a data base embedded in a non-transitory computer readable medium, foods not purchased from a grocery store or used in cooking method.

A user can elect to have all food purchases tracked in the central data in a user's profile so that recipes and a list of ingredients from restaurants can be uploaded to the central data base and accessed, shared or duplicated from the client device. User's can elect to share their profile with other users. In another particular embodiment of the system the input is a request for a recipe suggestion based on food aging data from a prior grocery store purchase in a data base of food aging based on age of the food on a date of purchase in the grocery store. In another particular embodiment of the system the input is a request for a recipe suggestion based on a time to cook and a learned cooking and preparation time of a user for a particular recipe selected from the client device. In another particular embodiment of the system the input data indicating a cooking utensil and data indicating culinary actions associated with the cooking utensil, the computer program further includes but is not limited to instructions to determine a size, thickness, diameter and type of the cooking utensil from the input data; instructions to determine an action associated with the cooking utensil from the image; and instructions to control a temperature for a stove top heating element associated with the utensil based on the determining of the size and type of utensil and the action.

In another particular embodiment of the system the input is a temperature from an infrared temperature probe of identified food being cooked according to the interactive cooking menu wherein a camera and image and motion recognition software computer program including but not limited to computer instructions embedded on a non-transitory computer readable medium are used to aim the temperature probe to an identified food item being cooked in an identified utensil on a stove top. In another particular embodiment of the system the input is a food color input indicating a food color change and cooking progress for the food, the method further including but not limited to controlling a cooking temperature for a stove top heating element associated with the food color change and presenting status of the food cooking based on the color of the food.

In another particular embodiment of the system the input is a texture input from a pair of imaging lens in the smart hood indicating a food surface texture change associated with a cooking progress the computer program further including but not limited to instructions to control a cooking temperature and presenting cooking status for the food cooking based on the texture of the food. Image analysis is used to determine texture and changes in texture to determine cooking progress of a food item. For example, battered chicken skin wrinkles changing the texture of the chicken skin when fried and thus indicates cooking progress based on a change in texture, i.e., wrinkling during frying. In another particular embodiment of the system the input is a gas chromatograph output indicating a simulated sense of smell associated with a particular food cooking progress, the computer program further including but not limited to instructions to control a cooking temperature for the particular food; and instructions to presenting status of the particular food cooking based on the gas chromatograph of the food, an identified action and an identified utensil wherein the camera identifies the action and the utensil. In another particular embodiment of the system the camera, gas chromatograph and temperature sensor are used to generate a status for a food being cooked.

The term system herein is used to describe the computer program software instructions embedded in the non-transitory computer readable medium, the processor which is executes the computer programs and all the hardware described herein including but not limited to the camera, display microphone and loudspeakers and the method for using the system.

Turning now to FIG. 1, in a particular illustrative embodiment 100 is depicted in schematic form. As shown in FIG. 1, a client device 114 such as a cell phone, personal data assistant, lap top computer or other portable wireless device such as an APPLE™ IPAD™ is provided. The client device includes but is not limited to a processor, memory and non-transitory computer readable medium for data storage. The processor on the client executes computer programs including instructions stored in the non-transitory computer readable medium. The client device display 112 is used to present an interactive cooking menu including but not limited to interactive icons 102, 104, 106, 108 and 110.

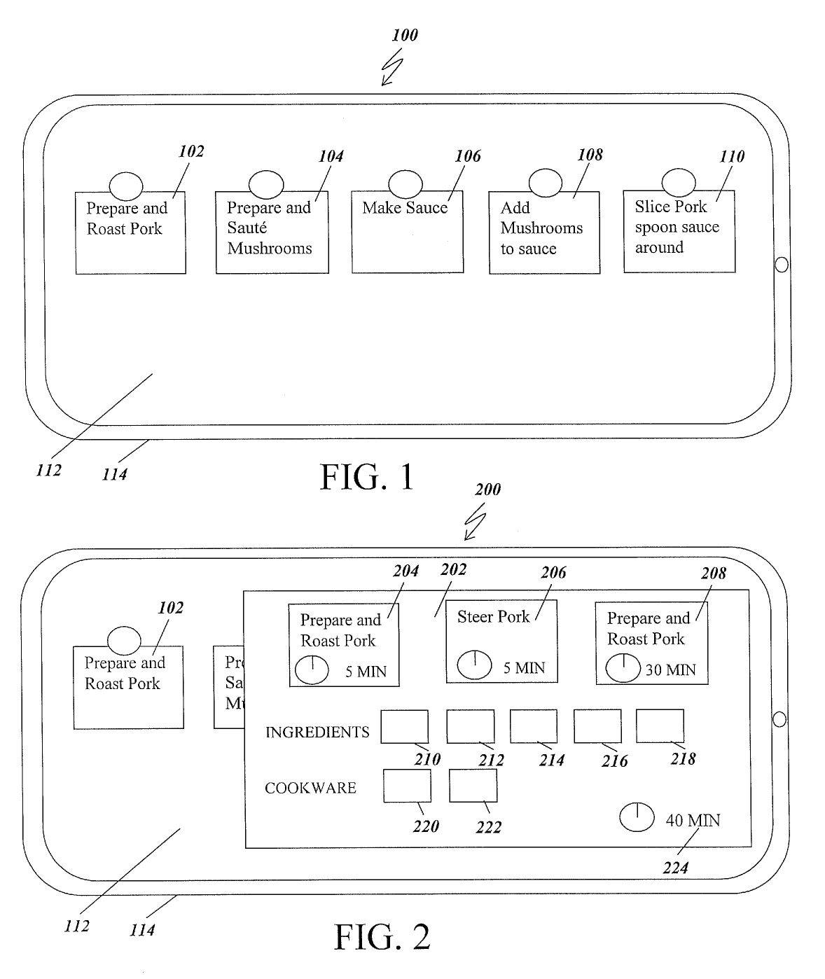

Turning now to FIG. 2, in a particular illustrative embodiment, activation (by voice, touching an interactive icon presented on the client device display or selecting the icon with a cursor generated user input device, not shown) of icon 102 is sensed by the client device processor using the computer program which generates sub-menu 202 for displaying additional information and selection options for the selected icon. In the present example, the “prepare and roast pork” icon 102 is selected. Upon the selection, the client device processor and computer program generate sub-menu 202. Sub-menu 202 displays a second level of interactive icons 204, 206 and 208. Icon 204 indicates the availability of instructions in the form of text, audio and video on how to prepare and roast the port. Historical information regarding how to prepare and roast the pork is also available through icon 204. Icon 206 indicates the availability of instructions in the form of text, audio and video on how to sear the pork. Historical information regarding how to prepare and roast the pork is also available through icon 206. Icon 208 indicates a time for preparing and roasting the pork. Ingredients are listed in icons 210, 212, 214, 216 and 218. Recommended cookware is indicated in icons 220 and 222.

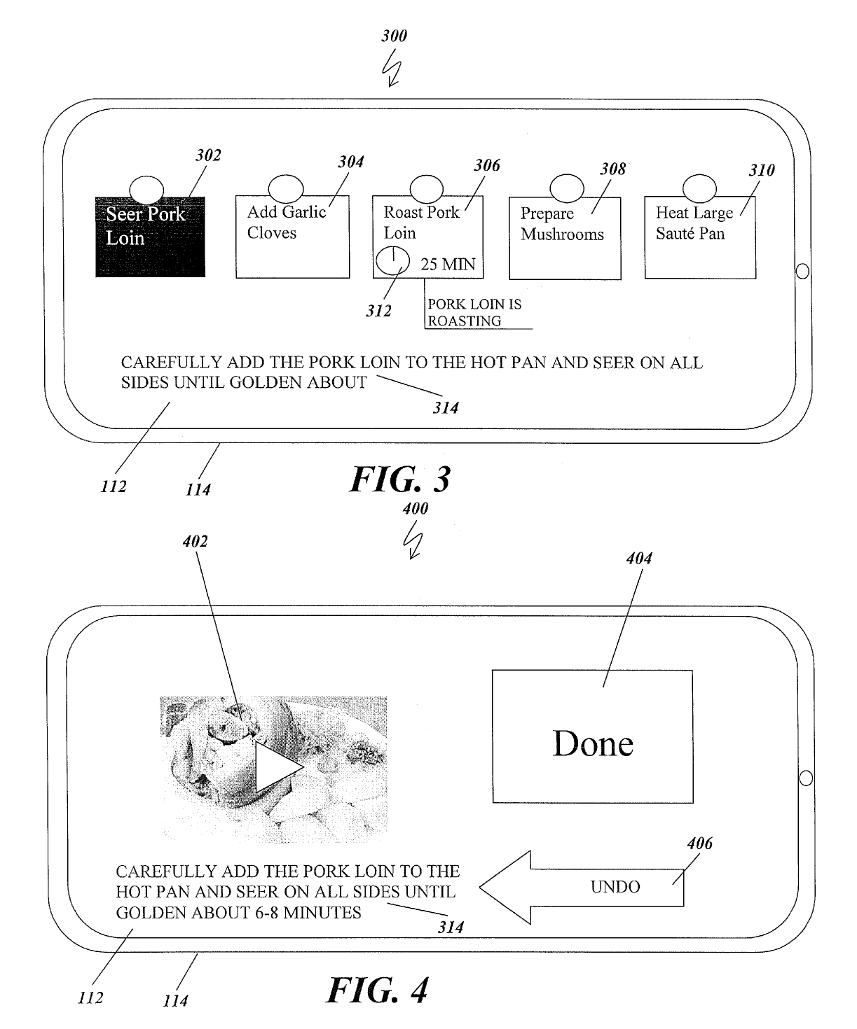

Turning now to FIG. 3, in a particular illustrative embodiment, interactive icons are presented on the client device display representing operations such as how to sear pork loin 302, add garlic cloves 304, roast pork loin 306, prepare mushrooms 308 and heat large sauté pan 310. A timer 312 icon is indicated for timing the roasting of the pork loin. A text message 314 is presented on the client device display for the selected icon 302 which has been selected as indicated by the darkened color of the icon.

Turning now to FIG. 4, in another particular illustrative embodiment 400, an iconic arrangement presentation is presented in which icon 402 indicates that a video for the selected how to sear pork icon 302 is available that when selected demonstrates how to sear the pork loin. A “done” button icon 404 is presented for selection by a user when the searing of the pork is completed. An undo icon button 406 is provided to exit the display 403.

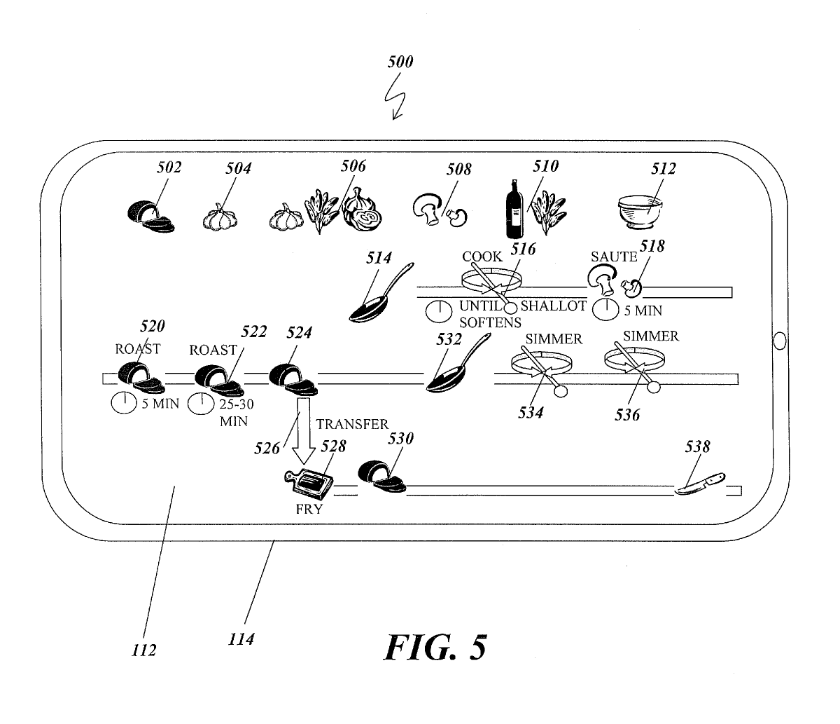

Turning now to FIG. 5, a schematic diagram is presented depicting an interactive cooking menu 500 is presented displaying interactive icons 502, 504, 506, 508, 510, 512, 514, 516, 518, 520, 522, 524, 526, 528, 530, 532, 524, 536 and 538. The interactive icons are displayed on the client device are interactive so that each icon is associated information regarding historical and operational information associated with a step in the cooking process. The icons selection can be displayed in story format, classical format or as a work board display. The story format presents operational and historical information regarding the preparation and ingredients associated with a particular cooking step, such as simmer 534. The icons represent ingredients, utensils, cook ware and preparation steps in a time line and inter dependency of the steps and ingredients in the preparation of a recipe displayed on the client device display. Work boards are pictorial or video displays of food preparation steps that can be accessed by selection of an icon.

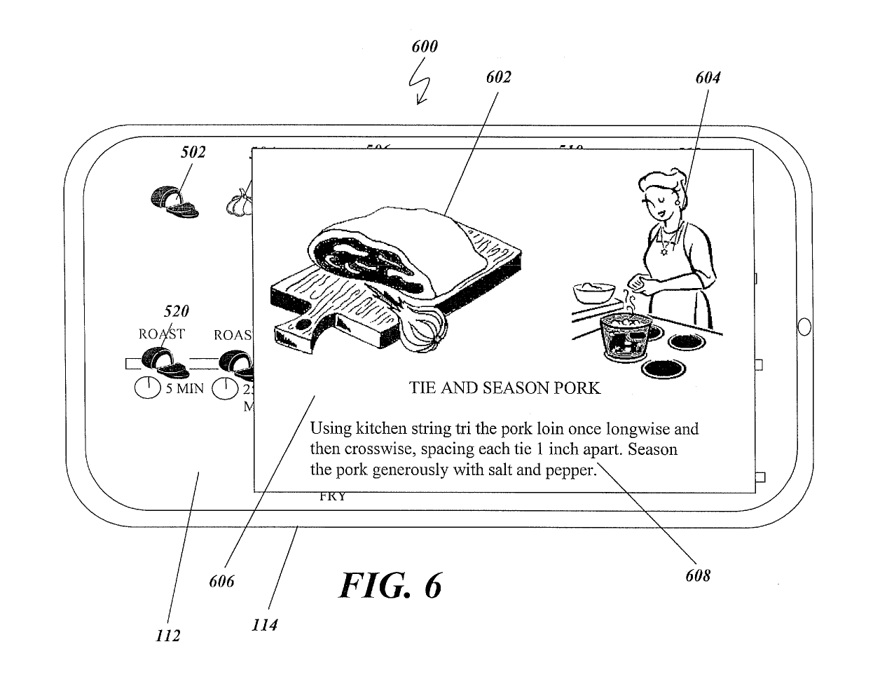

Turning now to FIG. 6, a schematic diagram is presented depicting a video presented on how to prepare the pork. In preparation for roasting tie and season the pork based on selection of icon seer port. A picture of the port is displayed 602, and along with an instructional image of a cook 604 demonstrating how to tie and season the pork. An instructional text message 608 is also displayed on how to tie and season the pork.

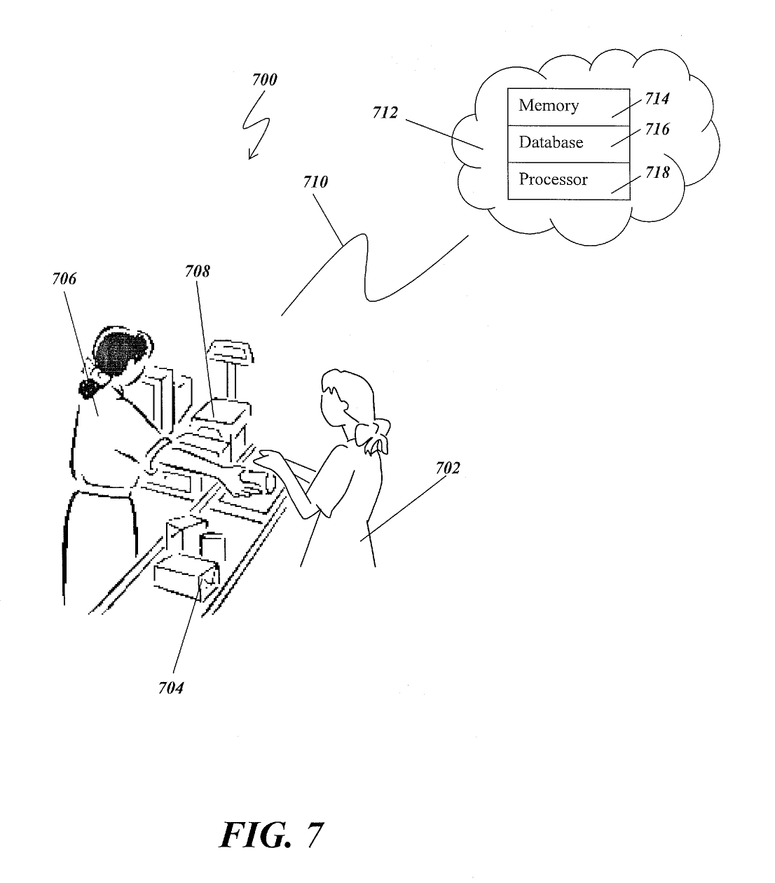

Turning now to FIG. 7, a schematic diagram is presented depicting a point of purchase food aging system at a grocery store. A grocery store records age information for each food item 704 associated with the food item's bar code. When the item is scanned 708, the bar code scanned indicates the scanned item's identity, quantity and age along with purchaser's identity 702, which are recorded in a central data base 716. The data base includes a processor 718 and a memory 714 embedded in a non-transitory computer readable medium. The database can be accessible as a networked data base, an attached data base or as a “cloud” data base housed at a central data base in a “cloud” environment 712.

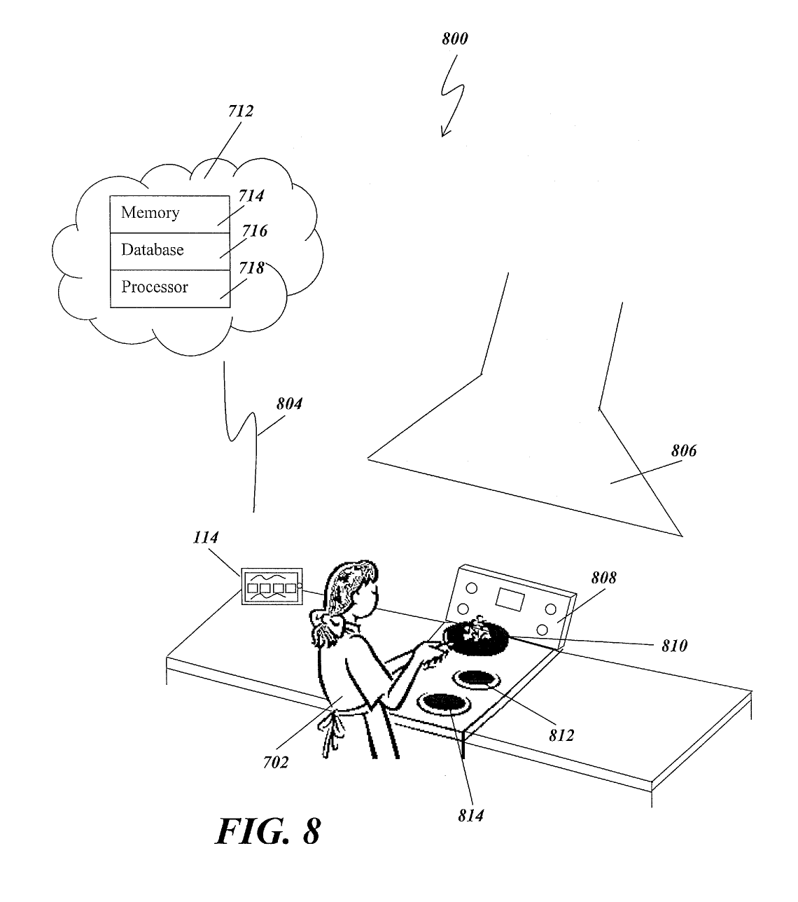

Turning now to FIG. 8, a user interacts with the client device which retrieves food aging information from the central data base. The client device 114 presents the interactive cooking menu on the client device display. The client device includes a processor and memory embedded in a non-transitory computer readable medium. The client device wirelessly communicates with the central data base 716. During the cooking process, the client device receives inputs from a set of culinary monitoring devices housed in an overhead smart hood 806 positioned above the cooking surface of a range. In a particular embodiment, the range includes but is not limited to an oven-stove/food preparation surface combination. The range includes but is not limited to a control panel 808, heating elements 812 and 814. The smart hood includes but is not limited to a processor with embedded computer programs in a non-transitory computer readable medium that uses a camera and image recognition computer program instructions to identify the user 702 and cooking utensil 810.

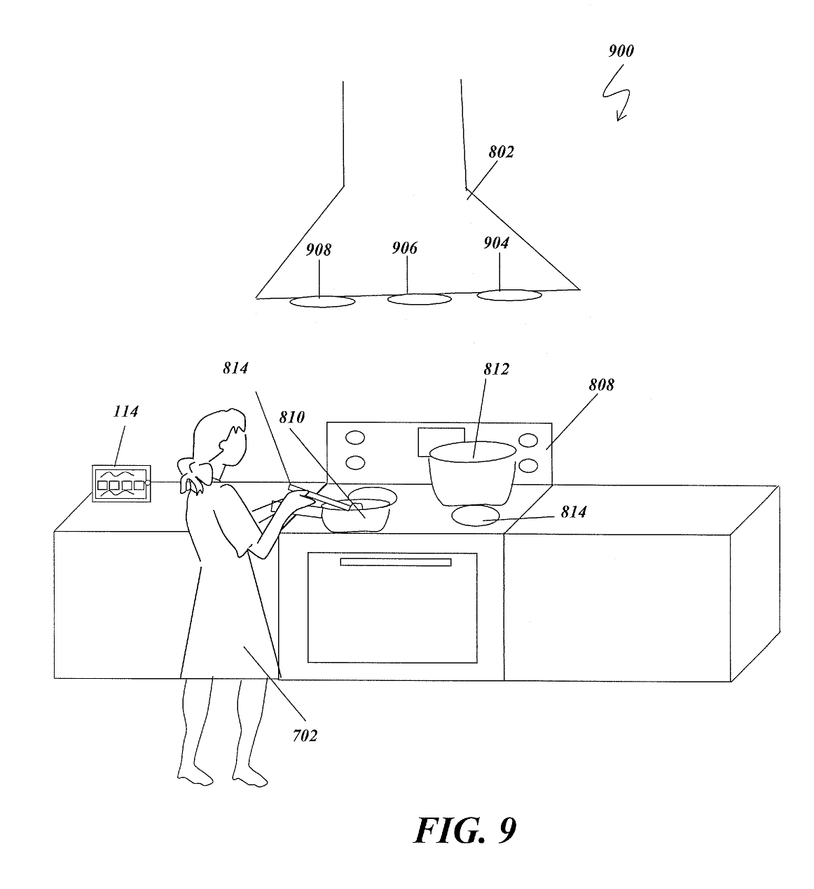

Turning now to FIG. 9, in a particular illustrative embodiment, the smart hood 802 includes but is not limited to culinary monitoring devices include but are not limited to an infrared grid projection and motion sensing system 908, such as a Kinect camera system including a RGB color camera 906, an infrared beam temperature sensor 906 and gas chromatograph 904 for simulating a sense of smell during the cooking process.

A cooking range is provided which includes a stove top includes burners (gas or electric), a griddle, hot plate and dual oven which are controlled partially by the client device. Cooking utensils such as pots 812, pans 810, forks, spoons 814 and spatulas and food are recognized and monitored during preparation and cooking by the culinary monitoring devices.

According to Wikipedia, based on industry reports, the Kinect system is based on software technology developed internally by Rare, a subsidiary of Microsoft Game Studios owned by Microsoft, and on range camera technology by Israeli developer PrimeSense, which interprets 3D scene information from a continuously-projected infrared structured light. This 3D scanner system called Light Coding employs a variant of image-based 3D reconstruction. The Kinect sensor is a horizontal bar connected to a small base with a motorized pivot and is designed to be positioned lengthwise above or below the video display. The device features an “RGB camera, depth sensor and multi-array microphone running proprietary software”, which provide full-body 3D motion capture, facial recognition and voice recognition capabilities. The Kinect sensor's microphone array enables a client device such as an Xbox 360 to conduct acoustic source localization and ambient noise suppression, allowing for things such as headset-free party chat over Xbox Live. The depth sensor consists of an infrared laser projector combined with a monochrome CMOS sensor, which captures video data in 3D under almost any ambient light conditions. The sensing range of the depth sensor is adjustable, and the Kinect software is capable of automatically calibrating the sensor based on gameplay and the player's physical environment, accommodating for the presence of furniture or other obstacles.

In a particular embodiment, the smart hood 902 includes but is not limited to an infrared beam temperature sensor 908. One example of an available infrared beam thermometer, is the Fluke 62 Mini Infrared Thermometer which safely measures material temperature without touching the material. Another example of an infrared beam thermometer for cooking is available as from Taylor which offers a Taylor 9251 Infrared Thermometer with a laser site for determining the temperature of a food, heating element or cookware while identified and locate food is being cooked. Infrared thermometers with laser sight are used monitor surface temperature during cooking, holding and serving. The Taylor 9251 is advertised to measure −58 to +750 degrees Fahrenheit. A camera is provided in the smart hood for the oven 906 which is used along with the Kinect system to detect and identify specific users at the cooking range, utensils, motion and gas chromatograph 904 for emulating a sense of smell during the cooking process. A smart vent hood and suction fan are positioned above the food being cooked so that fumes from the food rise up to the smart hood where fumes are analyzed by gas chromatography. The gas chromatograph performs electromagnetic spectroscopy on the exhaust fumes exiting through the exhaust vent in the smart from the food to simulate a sense of smell to determine the progress of food being cooked.

For example, the client device, using the smart hood culinary monitoring devices will identify the user 702 through voice and face recognition. The RGB camera and computer program in the client device are used in combination to perform object recognition to identify the face of the user. The object recognition software is also used to identify the utensils, cookware and sizes thereof. Thus, in a particular illustrative embodiment, the client device compute program locates and identifies cookware such as a sauce pan 810 as an 8″ sauce pan rather than a 6″ or 12″ sauce pan and adjusts the heat on the heating element underneath 8″ sauce pan 810 according to step of cooking in which the user is involved according to the client device 114 display. Once the 8″ sauce pan is identified and located, the client device computer program further identifies the cooking utensil as a spoon 814 in the 8″ sauce pan and motion associated with the spoon and food in the 8″ sauce pan. The infrared grid projection and motion sensing system sensing motion of identified utensils. The RGB camera provides image data which is used to determine the color of the food being cooked in the located 8″ sauce pan. The infrared thermometer is aimed at the located 8″ sauce pan and determines the temperature of the food being cooked in the 8″ sauce pan.

In a particular illustrative embodiment, when an icon is encountered on the client device during food preparation, indicating a cooking step for “sauté onions”, the client device computer program locates and identifies the 8″ sauce pan and spoon. The client device computer program associates the 8″ sauce pan 810 and spoon 814 with the task sauté onions. The computer program locates and identifies the boiler pot 812 also but does not associate the boiler with the sauté onions task as the computer program loads a context file from the data base on the client device which indicates which cookware and utensils relate to each task. Likewise the sauce pan 810 would be ignored in favor of the boiler 812 during a task involving boiling pasta. The client device computer program determines when the sauté onions are finished cooking. The RGB color camera determines when the onions in the sauce pan change color from white to a light brown during the sauté onion task and the gas chromatograph senses when the chemical composition of the fumes from the onions indicates the onions are emitting a sweet aroma during the sauté task. A temperature is also determined for the onions cooking in the sauce pan during the sauté onions task using the infra red thermometer. The combination of the color change, temperature and the sweet aroma indicate that the sauté onion task is complete. In another embodiment, any one of the color change, temperature and the sweet aroma indicate that the sauté onion task is complete. In another embodiment, any two of the color change, temperature and the sweet aroma, indicate that the sauté onion task is complete.

A motion detection system such as a Kinect style camera and motion detection system and image recognition software on the client device are used for detecting a particular type of cook ware such as a frying pay, sauté pan or boiler, a particular type of utensil such as fork, knife spoon and spatula and an action associated with the cookware or utensil. The size of the cookware is also determined by the client device processor using image recognition software. User activities are detected by the Kinect camera. Thus the client device computer program can determine when a user is stirring food in a particular type and size of utensil. The fumes from cooking are detected by the gas chromatograph. The image recognition software can also detect texture for example in determining when the texture of a food item changes during cooking to determining the cooking status of a food item. The image recognition software can also detect color for example in determining when the color of a food item changes during cooking to determining the cooking status of a food item.

According to Wikipedia, the Kinect system provides software technology that enables advanced gesture recognition, facial recognition and voice recognition. According to information supplied to retailers, Kinect is capable of simultaneously tracking up to six people, including two active players for motion analysis with a feature extraction of 20 joints per player, however, it has been stated that the number of people the device can “see” (but not process as players) is only limited by how many will fit in the field-of-view of the camera. The RGB video stream uses 8-bit VGA resolution (640×480 pixels) with a Bayer color filter, while the monochrome depth sensing video stream is in VGA resolution (640×480 pixels) with 11-bit depth, which provides 2,048 levels of sensitivity. The Kinect sensor has a practical ranging limit of 1.2-3.5 m (3.9-11 ft) distance when used with the Xbox software. The sensor has an angular field of view of 57° horizontally and 43° vertically, while the motorized pivot is capable of tilting the sensor up to 27° either up or down. The horizontal field of the Kinect sensor at the minimum viewing distance of ˜0.8 m (2.6 ft) is therefore ˜87 cm (34 in), and the vertical field is ˜63 cm (25 in), resulting in a resolution of just over 1.3 mm (0.051 in) per pixel. The microphone array features four microphone capsules and operates with each channel processing 16-bitaudio at a sampling rate of 16 kHz.

The combination of smart hood inputs from the smart hood culinary monitors (motion detection and identification system (i.e., Kinect), chromatograph, temperature and RGB color camera) for food color, simulated smell derived from the gas chromatograph mounted in a ventilation port through which cooking fumes are drafted into the smart hood, utensil type and size, user motion and determined activity in association with a particular food type, and in association with a particular step in the culinary process as directed by the interactive cooking menu presented on the client device are used to determine food cooking status and direct a user through the cooking process.

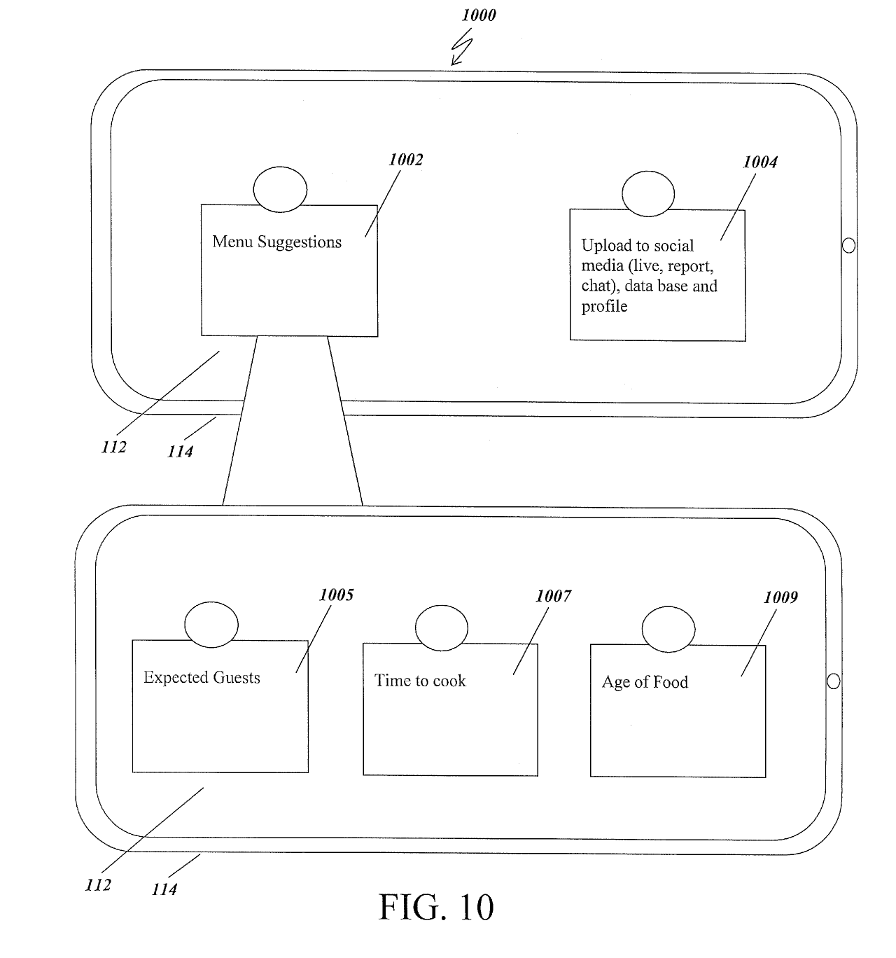

Turning now to FIG. 10, a schematic depiction of an illustrative embodiment 1000 an interactive cooking menu showing interactive icons is shown for allowing a user to request menu suggestions 1002, uploading to social media and the central data base 716 or to a user profile. Users can select to share their profiles on social media and on the central data base. Upon selection of the menu suggestions icon 1002 a sub menu 1003 of icons is presented wherein a user can select the basis for a menu selection. In a particular embodiment sub menu icons for menu selection are presented for basing menu selections on expected guests 1005, time available to cook 1007 and age of food 1009. Expected guest recipes are based the identity of the expected guests and their culinary likes and dislikes based on their user profile in the data base. Culinary likes and dislikes can also be harvested from profiles social media web sites such as FACE BOOK™, food purchase history in a grocery store and restaurants visited from cell phone applications such as FOUR SQUARE™ which in a particular embodiment are also combined into a user profile in the data base 716. The time to cook menu presents recipes that can be prepared in the amount of time available based on the adjusted cooking and preparation time learned for the identified user preparing the recipe. The age of food recipe suggestions are based on the aging information stored in the central data base from purchases made at the grocery store.

The upload icon enables a user to upload or send live user images including but not limited to pictures, comments and videos from the client device and smart hood camera and culinary monitors for uploading to a social network on the internet. The user images and video can be live or recorded for later uploading from the client device. Two different uses from two different client devices can communicate during cooking. A first user at a client device may interact on video, audio or pictures with another user at another client device so that one each user can see and hear the other during cooking. The user imagery and comments including an image of the final food product as prepared using the client device can be uploaded to a social media web site using the client device. The client device includes a processor, memory and data base for running computer programs that perform functions useful in supporting the functions performed in a particular illustrative embodiment of the present invention.

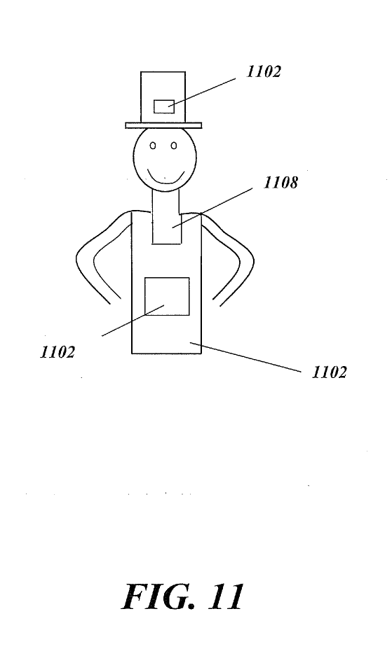

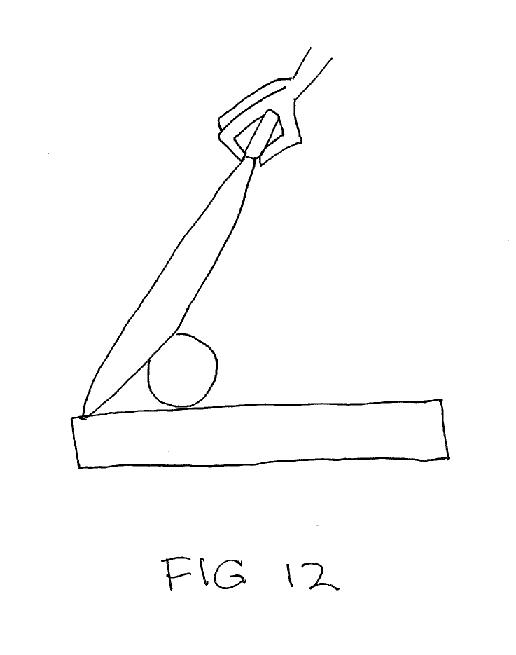

Turning now to FIG. 11, in a particular illustrative embodiment an imaging system 1102, such as the Kinect system is attached to the front of an apron 1106 and worn by a cook 1108 on their chest during cooking so that the system using the Kinect system can monitor the execution of cooking task by the cook 1108. The imaging system 1102 may also be a 2 dimensional, a 3 dimensional infrared or visible light imaging system. In any case, the imaging system 1102 facing the direction that the cook is facing and capture the cooks hand movements during food preparation, e.g., chopping and stirring. The imaging system 1102 has a visual beam width defined by dotted lines 1104 which provide visual feed back of the cooking process to the system. The hood 802 with sensors 904, 906 and 908 can also be provided and used in conjunction with the apron mounted imaging system 1102. The imaging system 1102 may also be mounted on a head gear such as a miner's helmet to provide imaging of the cook's activity during a cooking procedure.

Turning now to FIG. 12, a depiction of an image from the imaging system 1102 in FIG. 11 is shown. Thus, using the apron mounted imaging system, the activities of the cook can be monitored during a food preparation and food cooking operation. The actions of the cook can be monitored by the imaging system 1102 during chopping, stirring, mashing and slicing, etc. The actions of the cook monitored by the imaging system 1102 can be compared to stored reference actions to evaluate the performance of the cooking task. An audible input through a microphone or other aural sensor is provided to monitor the sounds of the cooking process. For example, the sound of sizzling bacon, pop corn popping, stirring, mixing and mashing certain foods during a particular cooking task are monitored and compared to a stored digital aural reference stored in a data base or memory in a non-transitory computer readable medium to evaluate the cook's performance of the cooking task. Thus, by monitoring the imaging system and the aural input the system can determine whether the cook is stirring at the right speed, in the proper manner (circular uplifting strokes in an object food, reciprocating strokes at the same depth in the object food, etc.) using the proper technique. The system also monitors the portion sizes for ingredients added during the cooking process to adjust a recipe to the ingredients added. A scale is provided under a burner to weigh the pan and the food ingredients placed in the pan to estimate a portion size, i.e. a pound of boned chicken or 1 pound of hamburger. In another embodiment, the portion size is estimated by a 3 dimension imaging system to estimate the volume of the portion, identify of the portion (hamburger, chicken, beans, etc.) and estimate a weight of the portion based on the estimated portion size and the identify of the portion.

In another illustrative embodiment, a live chef monitors the cook's progress during a cooking procedure via the imaging system on at least one of the apron mounted imaging system, head gear mounted imaging system and hood mounted imaging system. In another embodiment the system provides for face recognition of guest and accesses an identified guest's profile for culinary preferences such as favorite foods and spices based on social media profile and historical cooking procedures and visits to restaurants logged by FOURSQUARE™. In another embodiment, the system estimates volume and weight of chopped items such as celery or onions and adjusts the remaining ingredients volumes to match the estimated volume and weight. Thus, when a cook chops ⅓ coup of onion instead of ½ cup of onion the system reduces the remaining ingredients in the recipe to be proportionate to the reduced amount of onion. In another embodiment, the system learns the portions used by a particular cook and stores them so that the particular cook can share the recipe with other cooks using the systemas the system learned and stored it. Thus a second cook can reproduce the particular cook's recipe by using the estimated amounts of the ingredients used by the particular cook in the recipe as learned and stored by the system.

In another embodiment, the system presents recommendations, displayed or announced, for utensils and cookware for use by a cook in preparing a particular recipe and offers the utensils and cookware for purchase by the cook. The cook issues a verbal command to the system to accept the presented recommended offered utensils and/or cookware. In another embodiment, the system learns time required to finish a potion of a cooking procedure, e.g., chopping onions by monitoring a particular cooks historical performance of cooking tasks in a cooking procedure stored in the non-transitory computer readable memory data base. The system times and learns how long a particular cook uses to complete a particular task and adjusts time lines for other preparation steps to coincide with an estimated time of completion of the particular task.

In another embodiment, a holographic image of proper cutting technique is projected on the stove from the hood to demonstrate proper cutting technique. An image of food being properly cut using proper technique is projected as a holographic image of hands using a proper cutting technique and a proper utensil on a holographic image of a food on a cutting board. In another embodiment, an image of a live cook monitored by the system, using the smart hood and camera in a particular embodiment, in the kitchen during a cooking procedure is captured by the imaging system and sent to a processor for comparison to a reference for evaluation of proper technique. In another embodiment, the system uses a sound monitor such as a microphone in the smart hood to monitor a sound made by the cook during food preparation is used to evaluate the cooks cutting technique. In another embodiment, the pressure exerted by the cook with the utensil on the food on a surface such as a cutting board is measured by a scale on the cutting board or cutting surface used to evaluate the cooks cutting technique. In another embodiment, the pressure exerted by the cook chopping food with a utensil on the food on a surface such as a cutting board is measured by a scale on the cutting board or cutting surface used to evaluate the cooks stirring technique. In another embodiment, an angle of attack of a utensil by a cook during chopping of the food is estimated and compared to a reference for evaluation of the cook's chopping technique.

In another embodiment, the system audibly and visually presents via the display and an audible announcement from an audio speaker on the smart hood to display and announce when the cook is performing a task incorrectly, such as chopping with too much pressure or chopping with an improper angle for the utensil. In another embodiment, the system further includes apron with battery storage and blue tooth communications to receive commands from a processor in a particular embodiment.

In another embodiment induction cooking is used so that only the portions of a burner or pan that actually touch the food being cooked are heated. In another embodiment, radial waves of heat are sent from an electric cooking surface to apply heat from the electric cooking surface in an alternating heat wave pattern that spread from the center of a circular cooking surface in a radial traveling hot and cold pattern. The radial waves are controlled by a processor.

In another embodiment, robotic commands are issued to a robotic chef in the kitchen wherein the robot performs a cooking procedure in a kitchen. The actions of the robot are controlled by the cooking system. In another embodiment, the system is controlled by hand gestures of a chef appearing in the visible beam width of the imaging system. In another embodiment, the hand gestures are sensed, detected and measured by the imaging system. In another embodiment, the hand gestures are sensed, detected and measured by a wrist band placed around a cook's wrist. In another embodiment, the hand gestures are sensed, detected and measured by an accelerometer. In another embodiment, the system senses the size of a pan and overlays a holographic image of a particular portion size on the pan. In another embodiment, the system determines the size of the pan and recommends a different size pan based on the portion of a food being cooked in the pan.

In another embodiment, a gas chromatograph is provided and used to determine the chemical analysis, composition and make up of a smell for a particular food item being cooked. The chemical analysis is used to access the data base to find a corresponding odor or smell to cancel the odor by emitting the corresponding odor to cancel the smell of the food being cooked. A chemical mixture is emitted into the air to provide an odor canceling affect for the smell of the particular food item being cooked. In another embodiment, photonic storage is used to store holographic images in the system. In another embodiment the texture, color, sound, smell and temperature of a food being cooked is monitored to estimate when a food is properly prepared according to a recipe.

While the non-transitory computer readable medium is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computerized method comprising:
presenting from a client device processor, an interactive cooking menu on a client device display;
receiving on the client device an input regarding the cooking menu; and
responding to the input.

2. The method of claim 1, wherein the interactive cooking menu is a plurality of interactive icons and the input indicates progress toward accomplishment of a task related to a first one of the interactive icons.

3. The method of claim 2, the method further comprising:
changing the interactive cooking menu display to move to a second interactive icon related to the first interactive icon;
measuring a time to complete a first task related to the first interactive icon; and
storing a duration indicating a time to complete the first task for a particular identified user.

4. The method claim 1, wherein the menu is a plurality of interactive recipe icons and the input indicates a request for one of instructional and historical information about an icon, the method further comprising:
presenting instructional information on how to perform a task associated with a particular interactive icon, and presenting historical information related to the icon, wherein the historical information relates to a recipe origin.

5. The method of claim 1, wherein the input relates to the interactive cooking menu, and the responding to the input is posting the input to a social network.

6. The method of claim 1, wherein the input is a request for a recipe suggestion based on expected dinner guests, the method further comprising:
gathering at the client device, culinary preference information from social media on the internet indicating the expected dinner guests likes, dislikes, recent meals from four square restaurants, food purchases from store or indicated as used on the computer cooking method in a data base embedded in a non-transitory computer readable medium, foods not purchased from a grocery store or used in cooking method.

7. The method of claim, wherein the input is a request for recipe suggestion based on food aging data from a grocery store purchase in a data base of food aging based on age of the food on a date of purchase in the grocery store.

8. The method of claim, wherein the input is a request for recipe suggestion based on a time to cook and a learned cooking time of a user for a particular recipe selected on the client device.

9. The method of claim 1, wherein the input data indicating at least one of a cook ware and a cooking utensil and data indicating culinary actions associated with the at least one of cooking utensil and cook ware, the method further comprising:
determining a size and type of the at least one of cookware and cooking utensil from the input data;
determining an action associated with the at least one of cookware and cooking utensil from the image; and
controlling a temperature for a stove top heating element associated with the utensil based on the determining of the size and type of utensil and the action.

10. The method of claim 1, wherein the input is a temperature from an infrared thermometer of a food being cooked according to an interactive icon selected on a cooking menu wherein a camera and image and motion recognition software are used to aim the temperature probe to an identified food item being cooked in an identified utensil on a stove top.

11. The method of claim 1, wherein the input is a food color input indicating a food color change and cooking progress for the food, the method further comprising:
controlling a cooking temperature for a stove top heating element associated with the food color change and presenting status of the food cooking based on the color of the food.

12. The method of claim 1, wherein the input is a texture input indicating a food surface texture change associated with a cooking progress the method further comprising:
controlling cooking temperature and presenting status of the food cooking based on the texture of the food.

13. The method of claim 1, wherein the input is a gas chromatograph output indicating a simulated sense of smell associated with a particular food cooking progress, the method further comprising:
controlling a cooking temperature for the particular food and presenting status of the particular food cooking based on the gas chromatograph of the food, an identified action and an identified utensil wherein the camera identifies the action and the utensil.

14. The method of claim 1, wherein the camera, gas chromatograph and temperature sensor are used to generate a status for a food being cooked.

15. A system comprising:
a client device processor in data communication with a non-transitory computer readable medium;
a computer program comprising instructions embedded in the non-transitory computer readable medium, that when executed by a computer, perform functions useful in cooking food, the computer program comprising:
instructions to present from a client device processor, an interactive cooking menu on a client device display;
instructions to receive on the client device an input regarding the cooking menu; and
instructions to respond to the input.

16. The system of claim 15, wherein the interactive cooking menu is a plurality of interactive icons and the input indicates progress toward accomplishment of a task related to a first one of the interactive icons.

17. The system of claim 16, the computer program further comprising:
instructions to change the interactive cooking menu display of icons to move to a second interactive icon related to the first interactive icon;
instructions to measure a time to complete a first task related to the first interactive icon; and
instructions to store a duration indicating a time to complete the first task for a particular identified user.

18. The system claim 15, wherein the menu is a plurality of interactive recipe icons and the input indicates a request for one of instructional and historical information about an icon, the computer program further comprising:
instructions to present instructional information on how to perform a task associated with a particular interactive icon, and presenting historical information related to the icon, wherein the historical information relates to a recipe origin.

19. The system of claim 15, wherein the input is a request for a recipe suggestion based on expected dinner guests, the computer program further comprising:
instructions to gather at the client device, culinary preference information from social media on the internet indicating the expected dinner guests likes, dislikes, recent meals from restaurants, food purchases from store or indicated as used on the computer cooking method in a data base embedded in a non-transitory computer readable medium, foods not purchased from a grocery store or used in cooking method.

20. The system of claim, wherein the input is a request for recipe suggestion based on food aging data from a grocery store date of purchase in a data base of food aging based on age of the food on a date of purchase in the grocery store.
